(19) United States
(12) Patent Application Publication
(10) Pub. No.: US 2005/0018724 A1
(43) Pub. Date: Jan. 27, 2005

(54) Optical frequency synthesizer

(76) Inventors: Claudio Fernandes Castanheira Da Silva, Rio De Janeiro (BR); Alwyn Seeds, London (GB)

Correspondence Address: Thomas M Galgano;Galgano & Burke, Suite 135, 300 Rabro Drive, Hauppauge, NY, 11788, US

(21) Appl. No.: 10/479,889

(22) PCT Filed: Jun. 6, 2002
(86) PCT No.: PCT/GB02/02612

(30) Foreign Application Priority Data
Jun. 7, 2001 (GB) 0113911.2

(51) Int. Cl. H01S 3/13

(52) U.S. Cl. 372/32

(57) ABSTRACT

Laser frequency locking apparatus (5), comprising: a slave laser (15), having associated with it means (14, 18) for coupling and/or means (18, 25) for coupling and propagating signals received and emitted; a phase lock loop (24); and a controller (16), operable to control the slave laser, wherein an output of a reference signal source (1) associated with a master source (2, 3), and receivable therefrom, is utilised in the phase lock loop to render the output frequency of the slave laser the same as an output frequency of the master source. The invention described relates to a technique for generating a set of highly stable optical frequency channels. There are provided methods and systems of locking laser frequencies and of synthesizing frequencies.

This invention relates to a method and systems/apparatus for synthesizing optical frequencies. More specifically, this invention relates to apparatus for stabilising the frequency of optical carriers, and methods for using those apparatus for synthesizing optical frequencies.

For fibre optic wavelength division multiplex (WDM) telcommunications networks with high spectral efficiency, information has to be sent over optical carriers that present a small amount of drift in frequency. Currently deployed approaches use channel lasers having their oscillation frequency dependent on temperature variations and variations in injection current. Although very careful designs of control circuits for both variables have been implemented, frequency drifts of >140 MHz around the desired frequency, over a period of a few minutes, are still the best achievable when using Peltier cooler based temperature controllers and low noise current sources. In commercial WDM systems, locking to a resonance of an optical etalon is used to improve long term drift, and long term stability of ±3 GHz is typically obtainable.

A much more complicated and expensive technique for better stabilization makes use of the absorbtion peak of an atomic gas line. This technique involves the use of a gas cell which generates a voltage dependent on the frequency difference between the highly stable atomic line of the special gas in the cell and the unstable laser line travelling through it. It then generates an error signal to be fed back to the laser injection current, in a frequency control loop configuration. Achievable stabilization figures can reach a few tens of kHz when using this method. However, from considerations of physical dimensions, price and flexibility, the application of this technique to a large number of channel lasers is not viable.

One way to overcome the above problems is to use an optical frequency comb generator (OFCG), in which a single stabilized laser line generates many other optical carriers, the spacing between them being set by a microwave synthesizer (frequency error of less than 1 Hz obtainable). However, this leads to another problem. At the output of an OFCG, all optical carriers are present in the same fibre at the same time. For a network to operate, these carriers must be individually filtered so that they can be independently modulated with information to be sent, before they are coupled to a common output. If high density WDM systems with channel separation of less than 25 GHz are to be built, quite stringent specifications for these filters apply. For example, the necessary spacing and isolation between channels are required to be <0.2 nm and <30 dB respectively.

Known optical filters such as Fabry-Perot (FP) filters (fiber, liquid crystal or micromachine based), fibre gratings and acousto/electro-optic filters face substantial technological challenges when it is attempted to use them to achieve these specifications. Active filters based on semiconductor lasers operating below their threshold point produce an effective filter (using the resonance characteristic of those devices). They have been demonstrated using FP filters, distributed feedback (DFB) filters and distributed Bragg reflector (DBR) filter structures, with features such as narrow filter bandwidth (<0.1 nm). These add a fundamental characteristic for routeable WDM networks: fast electrical tuning (˜ns).

A similar approach is to use a laser biased over threshold, and to lock its optical frequency to that of one of the comb of optical carriers generated by the OFCG. This selection mechanism is attractive since the output frequency of the laser exactly equals that of the comb line to which it is locked. Also, because the output power is approximately equal to the free running power of the locked laser. This removes the need for optical amplifiers in the channel source. Depending on the locking system, selected lines can maintain exact phase lock to the master laser. Therefore, the high accuracy and stability of the absolute optical and microwave frequency references driving the comb source are retained.

Prior art locking mechanisms for stabilisation of laser emission include optical frequency locking loop (OFLL) and optical injection locking (OIL). OFLL is the most simple system for locking a slave laser to a master comb line. It consists of heterodyning a master and a slave laser signal in a photodetector. This generates an electrical signal of frequency f_{b} corresponding to the frequency difference between the two lasers. An electrical frequency discriminator is then used to convert f_{b} frequency variations into voltage variations. The voltage variations are then used to drive a control circuit which generates an error signal that is fed back to the slave laser diode in order to correct it's frequency. This approach has three disadvantages. First, the slave laser output frequency is offset from the comb line frequency. Second, as a frequency locking technique, finite frequency error is always introduced relative to the comb line frequency. Third, the phase noise of the two lasers is added, creating noise in the error signal. These disadvantages limit the capability of an OFLL locking system.

Heterodyne optical phase lock loop (OPLL) is also based on mixing master and slave laser signals in a photodetector, thereby generating an electrical signal of frequency f_{b} corresponding to the frequency difference between the two lasers. However, in a heterodyne OPLL the beat note is sent, together with the signal, from a reference electrical oscillator (set to generate exactly the desired frequency difference f_{b},), to a phase detector. In this way, the phase variations of the slave laser generate an error signal, at the phase detector output, which drives a control circuit responsible for correcting the slave laser phase. This control loop permits absolute frequency offset control and phase noise tracking, but demands narrow linewidth lasers and/or low delay electronics (of the order of hundreds of picoseconds for monolithic semiconductor lasers). It also requires extremely short optical path lengths in the loop, typically less than a few millimetres. Again, the output frequency is offset from the comb line frequency. A stable electrical oscillator of frequency f_{b} is also required. These drawbacks limit the feasibility of heterodyne OPLL, although many applications can be implemented through micro-optical integration of system components.

Prior art heterodyne implementations of OPLL make use of different microwave references f_{REF} for the OFCG and the frequency offset (f_{b}) at the OPLL phase detector, with f_{b}<f_{REF}. The use of this kind of heterodyne OPLL in optical frequency synthesisers has been proposed elsewhere.

The homodyne implementation of OPLL has an additional disadvantage. That is, the master and slave laser emissions occur at the same frequency, producing a null f_{b}. Extrinsic low frequency noise sources and excess intensity noise of semiconductor lasers will then induce noise in the resultant signal. Therefore, in homodyne OPLL, there is a need for very carefully designed broadband balanced detection schemes to detect DC level variations after the mixing of the two laser emissions. This is a considerable drawback.

OIL utilises the injection of light, from the master source/laser, into the slave laser cavity. The injected light serves as a reference seed for the slave laser, guiding its stimulated emission process to generate light of the same frequency, linewidth and frequency stability as the incoming light. This defines the locking process. Locking occurs when the slave laser free running frequency offset (from that of the master laser) falls inside a range called the “frequency locking range”. This approach produces a slave laser emission frequency which is phase locked to that of the master laser, but which lacks robustness against environmental fluctuations. Variations in the temperature and injection current of the slave laser can easily destroy the locking condition, due to the fact that only small locking ranges are achievable. Typically, the locking range for the OIL technique is of the order of 1 GHz. Also, it must be kept smaller than 10% of the comb line frequency spacing to avoid the risk of the slave laser locking to an adjacent comb line.

It will be clear from the above that there exist a number of problems with the currently used methods/apparatus for locking the output frequency of a laser to that of a master source. Accordingly, the present invention seeks to address one or more of these problems.

In this regard, the present invention provides laser frequency locking apparatus, comprising; a slave laser, having associated with it means for coupling and/or means for coupling and propogating signals received and emitted; a phase lock loop; and a controller, operable to control the slave laser, wherein an output of a reference signal source associated with a master source, and receiveable therefrom, is utilised in the phase lock loop to render the output frequency of the slave laser the same as an output frequency of the master source.

Preferably, the means for coupling associated with the slave laser comprises at least one coupler. Preferably, the apparatus further includes a beat note generator, wherein the beat note generator is a photodetector. Preferably the phase lock loop includes a microwave amplifier, a mixer and a control module. More preferably the output of the reference source is connected to the mixer through a delay line.

Preferably, the control module includes a low pass filter, an offset control and a gain control, each preferably associated with a differential amplifier and loop filter. More preferably, the control module further includes a limiting circuit.

In a preferred embodiment of the present invention, the controller operable to control the slave laser is a current and/or temperature controller and is in operational communication with the slave laser. Preferably, the beat note generator, the phase lock loop and the controller operable to control the slave laser form a control loop which operates to lock the output frequency of the slave laser to a desired frequency. More preferably, the controller is operable to compensate for variations in the slave laser temperature and for disturbances to the equilibrium of carriers within the slave laser.

In a preferred embodiment, there are associated with the slave laser a pair of couplers. Preferably, a first coupler is in optical communication with the output of the slave laser, and serves to split that output. More preferably, the first coupler splits the output of the slave laser in the ratio of about 1:9, such that about 90% of the output is output by the apparatus. Of course, other ratios such as 85:15 or 8:2 are equally applicable and may be utilised within the apparatus. More preferably, a second coupler is in optical communication with the first coupler and a portion of the output of the master source, and the output of the second coupler is in optical communication with the beat note generator.

In a further preferred embodiment of the present invention, the coupler is in bi-directional optical communication with the slave laser, and with a circulator, the coupler serving to split the output of the slave laser in the ratio of about 1:9. As above, other ratios apply equally. Preferably, the majority ouput of the coupler is output by the apparatus and the minority output of the coupler is communicated to the circulator. The circulator may operatively connect the output of the master source with the circulator and thus the slave laser, and the minority output of the coupler, combined with the output of the master source, with the beat note generator.

According to a still further preferred embodiment of the present invention, the output of the master source is in direct optical communication with the slave laser, and the slave laser is in optical communication with the coupler. Preferably, the coupler is to split the output of the slave laser in the ratio of about 1:9, the minority output being connected to the beat note generator and the majority output being output by the apparatus. Again, other ratios, as set forth previously, apply equally.

Also in accordance with the present invention there is provided an optical frequency synthesiser comprising: a master source module; a first coupler; a channel allocation bus; a data bus; a plurality of laser frequency locking apparatus; a plurality of modulaters each associated with a laser frequency locking apparatus; and a second coupler.

Preferably, the master source module includes a stablised reference laser in optical communication with an optical frequency comb generator, and a microwave reference source. More preferably, the optical frequency comb generator is in optical communication, via the first coupler, with each laser frequency locking apparatus. Still more preferably, the output of each laser frequency locking apparatus is in optical communication with a modulator. The output of each modulator may be in optical communication with the synthesizer output, via the second coupler. Additionally, the channel allocation bus may be in controlling communication with each laser frequency locking apparatus, and the data bus may be in communication with each modulator.

Also in accordance with the present invention there is provided a method of locking a laser output frequency, comprising the steps of: combining a portion of a slave laser output with the output of a master source; generating a beat note signal; combining the beat note signal with the output of a microwave reference source associated with the master source; determining whether the frequency of the beat note varies in relation to that of the microwave reference; and if it does: generating an error correction signal; and adjusting the current and/or temperature of the slave laser, in order to retain the output frequency of the slave laser at a desired frequency.

Preferably, the beat note signal has a frequency equal to the difference between frequencies of output of the master source and slave laser. More preferably, the beat note signal is amplified prior to its mixing with the reference signal. Still more preferably, the master source generates a frequency comb and the step of determining includes determining whether the beat note frequency varies such that it reflects a comb line other than that desired.

Various specific embodiments of the present invention are now described, by way of example only, with reference to the accompanying drawings, in which:

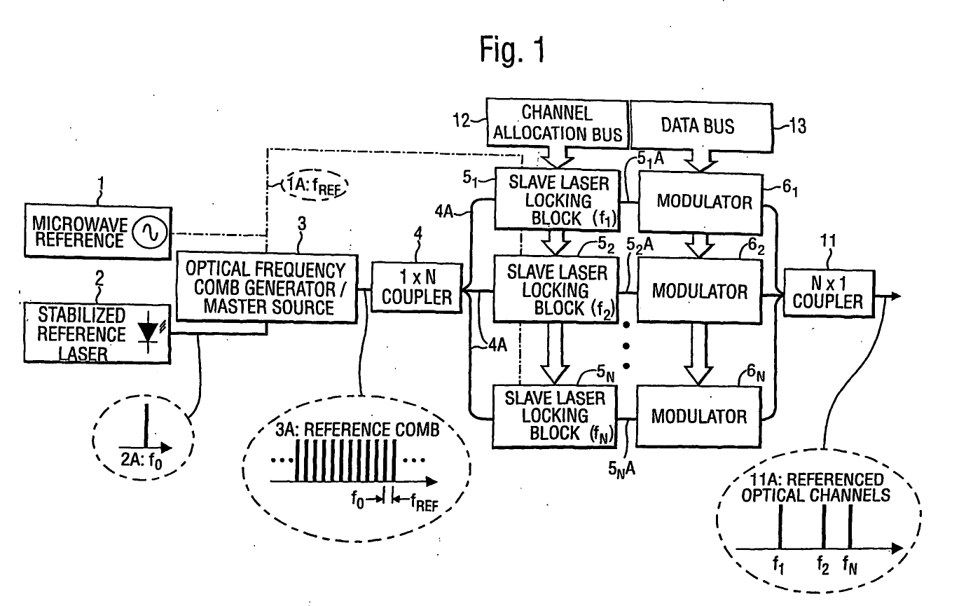

FIG. 1 shows a specific realisation of a system incorporating and embodying the present invention;

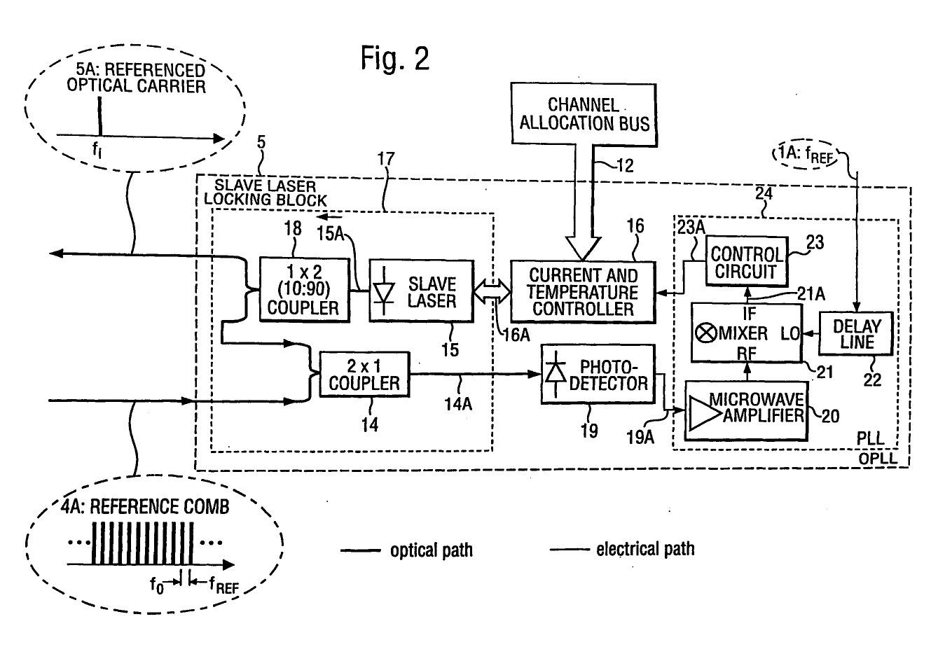

FIG. 2 shows a specific realisation of the laser locking block according to FIG. 1;

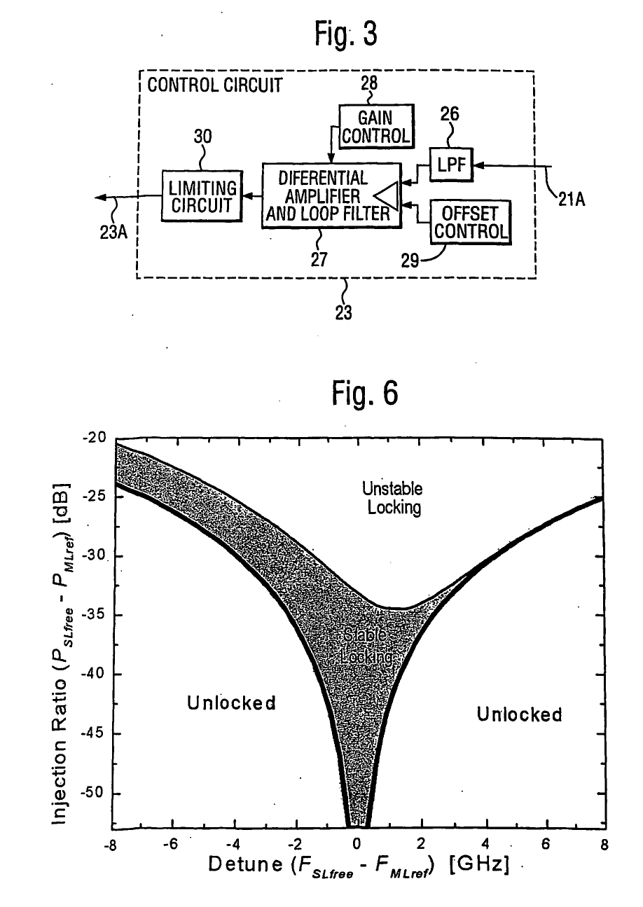

FIG. 3 shows a specific realisation of the control circuit or module as shown in FIG. 2;

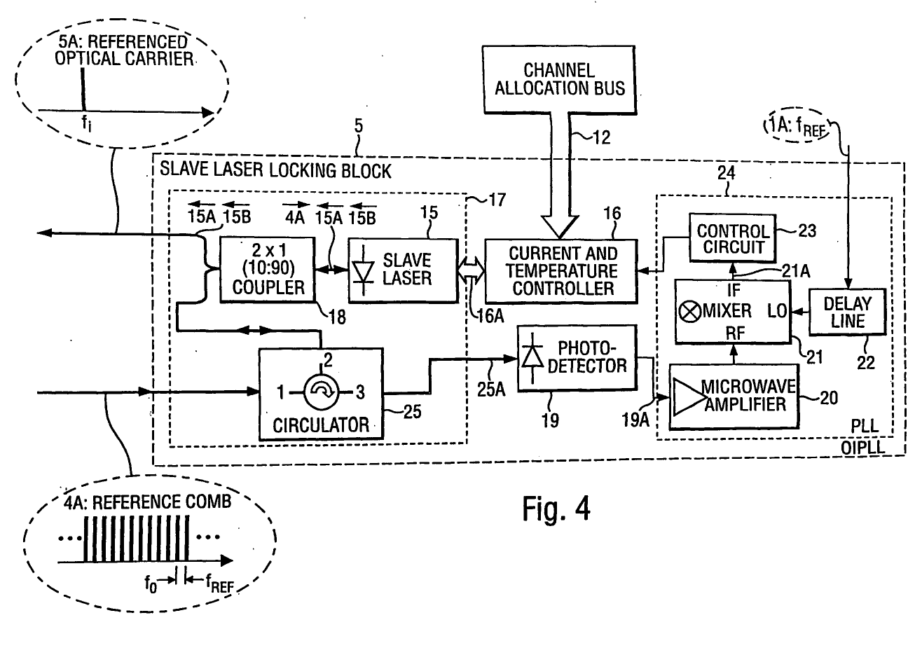

FIG. 4 shows an alternate realisation of the laser locking block of FIG. 1;

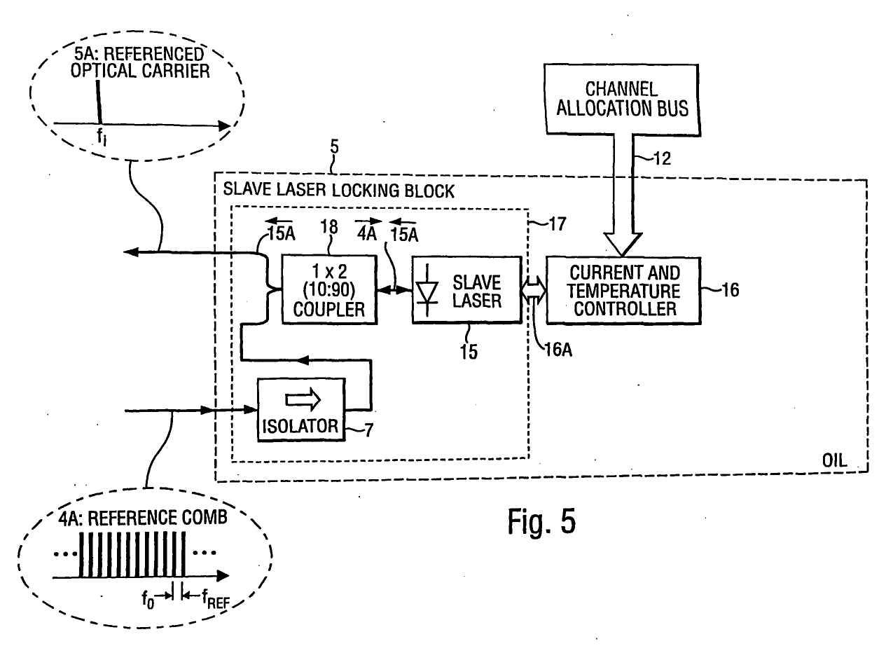

FIG. 5 shows a prior art implementation of the laser locking block utilising optical injection locking;

FIG. 6 depicts the stable locking region of the system of FIG. 5; and

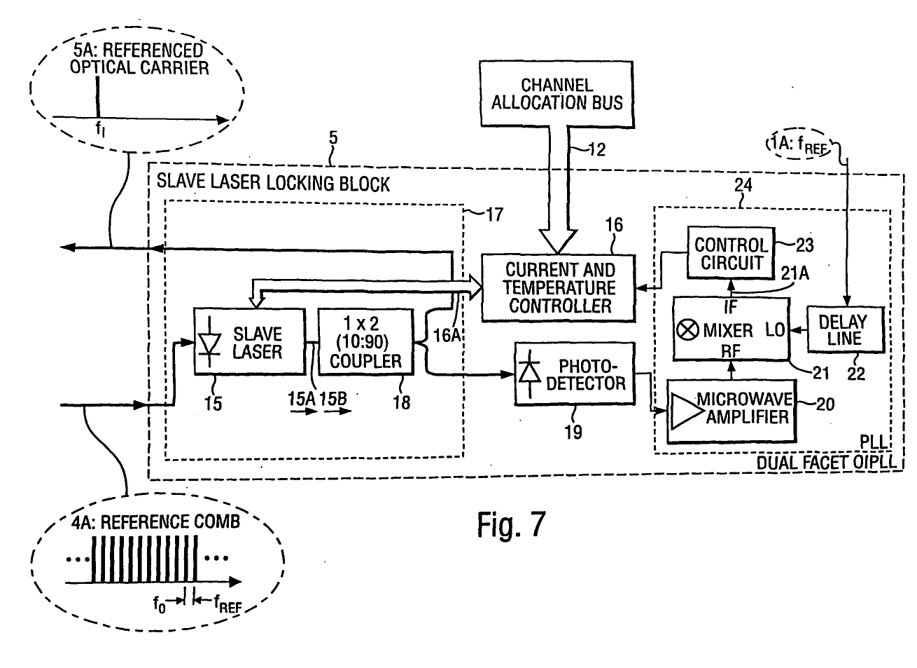

FIG. 7 shows another alternative realisation of the laser locking block of FIG. 1.

This invention discloses two new locking mechanisms. The first one relates to a heterodyne optical phase lock loop (OPLL) which uses the same microwave reference source as the OFCG. The second one leads to superior optical frequency synthesis performance through the combination of the OIL and heterodyne OPLL techniques, in a so called optical injection phase lock loop (OIPLL) scheme.

The heterodyne OPLL technique for locking a slave laser to a master source comb line disclosed below eliminates offset f_{b} and uses only one reference microwave source, with consequent decrease in system cost and complexity, by using the same reference oscillator as the optical frequency comb generator. Locking the phase of a slave laser to that of one of the generated comb lines is achieved by mixing a fraction of the generated optical carrier power with the adjacent comb lines, as will be described in detail below.

OIPLL is the combination of the OIL and OPLL techniques. As in an OIL system, a portion of the light from the master source is sent to the slave laser cavity. However, in the OIPLL system, both the slave laser and another portion of the master laser emissions are mixed in a photodetector giving, as a result, a signal that is used to drive a circuit similar to that used in OPLL. Phase locking of the slave laser is then accomplished by conjunct actuation of both techniques. By combining the wide locking range and good phase tracking capabilities of the OPLL system with the relaxed requirements for laser linewidth and loop length of the OIL system, a robust locking circuit is generated. Set forth below is an heterodyne OIPLL technique for locking a slave laser to a master source comb line with no offset, using only one reference microwave source. Locking the phase of a slave laser to that of one of the comb lines is achieved by mixing the generated optical carrier with the residual adjacent comb lines reflected from the slave laser facet or transmitted through it.

Referring to FIG. 1 of the drawings, there is shown an optical frequency synthesis system. The system comprises: an optical frequency comb generator (OFCG) 3 working as a master source; a 1×N coupler 4; a plurality of tuneable locking filters comprising slave laser locking blocks (5₁ . . . 5_{N}); a plurality of optical modulators (6ᵢ . . . 6_{N}); and a N×1 coupler 11. The system produces a WDM output signal 11A in which channel spacing stability and absolute frequency accuracy are determined by a microwave reference source 1 and a laser reference source 2.

In this system, a comb of optical frequencies 3A is generated by an OFCG 3 which is driven by a stabilized reference laser source 2 and a microwave frequency reference source 1. The comb 3A central frequency is set by the reference laser source 2 output signal 2A (f₀) and has the same frequency stability. The comb line 3A spacing is set by the microwave reference source 1 output signal 1A (f_{REF}) and has the same frequency stability. For a microwave reference frequency source of high spectral purity, the reference comb lines 3A assume the same linewidth as the reference laser output signal 2A, and have power stability dependent on the utilized OFCG 3 structure. The OFCG 3 functions as the master source, supplying a high quality signal 3A for a plurality of slave lasers included in the slave laser locking blocks 5₁ . . . 5_{N}. The 1×N coupler 4 has the objective of distributing the same reference comb to the input of each of the locking blocks 5₁ . . . 5_{N}. Therefore, in each of the output ports the same signal 4A will be present, each being a copy of the reference comb 3A attenuated by a 10*Log(1/N) factor.

Each of the locking blocks (5₁ . . . 5_{N})make use of one, and only one, of the lines from the attenuated reference comb 4A to lock its slave laser, blocking the propagation of the other reference comb lines in 4A, so that their output signals 5₁A . . . 5_{N}A comprise single frequencies (f₁. . . f_{N}) that are different from each other. The information regarding which reference comb line 4A each slave laser locking block 5₁ . . . 5_{N} should lock to comes from a channel allocation bus 12 which feeds all blocks. These referenced optical carriers are as stable in frequency as the stabilized reference laser source 2, assuming a stable microwave reference source 1. Each of the optical carriers is modulated by different optical modulators 6₁ . . . 6_{N}, so different data is transmitted over each carrier, comprising the different channels in this WDM source. The modulators 6₁ . . . 6_{N} are fed by modulating signals from a data bus 13. All channels are then coupled together in a N×1 coupler 11, presenting at its output an output signal 11A in which all different channels are present.

The core of the technique of the present invention resides in the slave laser locking blocks 5₁ . . . 5_{N}. The present invention encompasses two methods for locking a laser to one of the lines of the reference comb in signal 4A. They differ from each other generally in the complexity of their implementation. However, other differences will become apparent upon reading the following.

The first method uses an heterodyne OPLL arrangement, as may be seen in FIG. 2. The output 15A, of a slave laser, is split by an unbalanced optical coupler 18, directing, for example, 10% of its power to a further optical coupler 14. This also receives light from the master source (signal 4A). Both signals 15A and 4A are then directed to a photodetector 19. The photodectector generates an electrical beat note signal 19A with a frequency that equals the frequency difference between the two signals 15A and 4A received. If the slave laser 15 is emitting a frequency close to that of one of the reference comb lines 4A, which are spaced by f_{REF} (signal 1A), microwave components close to frequencies f_{REF}, 2f_{REF}, 3f_{REF} . . . kf_{REF} (where k is an integer) will be contained in the photodetector output 19A. The number of frequency components to be generated is limited by the photodetector response, which needs only to reach f_{REF}.

Inside a PLL block 24 which is a module of the system of the present invention, and after proper amplification by the microwave amplifier 20, the optically generated microwave signal is mixed with the signal 1A produced by the microwave reference oscillator 1, in microwave mixer 21, after it's propagation through a delay line 22. When the frequency of the slave laser 15, that originally is not locked, varies and reaches the same value as one of the referenced comb lines 4A, the beating process (i.e. the generation of a beat note signal) generates a DC level signal at the mixer 21 IF port. This signal varies according to variations in the relative phase between the two signals. Other beating modes are not relevant and are blocked by an input low pass filter present at the input of the next block, a control circuit 23. This control circuit, depicted in FIG. 3, comprises a low frequency differential amplifier and loop filter 27, responsible for amplifying the DC level signal 21A. The loop filter time constants are selected to optimise the dynamic response of the control loop. A gain control 28 and an offset control 29 are included so the output signal 23A of the PLL block 24 can be customised to the input of the current and temperature controller 16. A limiting circuit 30 is optional and may be included to prevent the slave laser 15 having its temperature or current changed to values exceeding acceptable and/or defined limits.

The current and temperature controller block 16 has the objective of maintaining stable the slave laser 15 chip temperature and injection current. Commercial controllers enable a maximum short term frequency stability of ˜140 MHz, which is enough to avoid a slave laser 15 free running frequency drift that would fall outside the frequency locking range. The block also has the function of tuning the free running frequency to be close to the desired reference comb line to which it is to be locked. This information is transferred to the controller block 16 from the channel allocation bus 12.

The PLL circuit 24 produces a phase tracking system, wherein any alteration in the operating conditions of the slave laser 15 that would produce a change in its emission frequency is compensated by the loop 24. The loop produces, in the input of the current and temperature controller 16, a signal that will modify the slave laser 15 current and/or temperature, thereby keeping it in phase lock to one of the reference comb 3A lines. The response time of the PLL circuit 24 is defined by the loop length delay and the response of the loop filter and other circuit elements in the loop.

The second technique/apparatus of this invention makes use of an OIPLL set up. FIG. 4, which corresponds largely to FIG. 2, shows the arrangement The alteration introduced in block 17 of FIG. 4 results in the reference comb signal 4A being injected into the slave laser 15 cavity, forming an OIL arrangement. The addition of this connection gives a more flexible, whilst equally robust, implementation of OPLL.

The OIL technique is first described with reference to FIG. 5. In this figure, an example arrangement for sending the reference comb signal 4A to be injected in the slave laser 15 is presented. The reference comb signal 4A passes through an optical isolator 7 and a coupler 18 on its way toward the slave laser 16 facet. For clarity purposes the signal emitted from the isolator 7 will hereafter be considered as signal 4A. The slave laser 15 should not have an optical isolator in front of its facet. This feature is normally included in commercial laser modules to avoid spurious light getting into the laser cavity, leading to interferometric noise in a regular application.

For OIL operation purposes, the light incident in the laser cavity works as a reference seed, guiding the laser stimulated emission physical process to generate light with the same frequency, similar linewidth and frequency stability to the incoming light 4A. A single mode laser is used as the slave laser 15. This class of laser structure incorporates a wavelength filter in its cavity. This ensures that the slave laser 15 light emission will be locked to one, and only one, of the reference comb lines present in the incoming signal 4A. All the other lines are strongly attenuated inside the cavity.

Light emitted by the slave laser 15 (signal 15A, here called the referenced optical carrier) will be locked to the line from the reference comb (4A) that falls inside the injection locking range. This is defined by a relation between the power difference between the free running slave laser 15 (P_{SLfree}[dBm]), and the reference line from the master source 3 (P_{MLref} [dBm]), and the frequency difference between the free running slave laser (F_{Slfree}), and the referenced line from the master source 3 (F_{Mlref}), which is depicted in FIG. 6 by an example curve.

The reference light emitted from the slave laser 15 cavity propagates through the same optical path (but in the reverse direction with respect to signal 4A) towards coupler 18. It has, for example, 90% of its power transmitted to the slave laser locking block 5 output, composing the referenced optical carrier for one of the channels of a WDM system. The other 10% travels through the other branch of the coupler 18 and is absorbed by the isolator 7. Practical locking ranges using the OIL technique alone span from a few MHz to a few GHz, depending on the above parameters and the slave laser structure.

Using the above considerations (OIL and OPLL), there follows a description of the OIPLL system of FIG. 4. Essentially, it consists of the same OPLL configuration block 17, but substitutes the 2×1 coupler 14 of FIG. 2 with an optical circulator 25. The objective of this new circuit is to achieve a wide frequency locking range, using relaxed design parameters giving more robustness for the optical frequency synthesis technique. The increase in the frequency locking range when compared to FIG. 5 achieved using OIL techniques alone can be as much as 200 times, i.e. reaching values >>100 GHz. This is, however, limited by the tuning range of the slave laser being controlled by the PLL block 24. Assuming a typical value of 20 GHz/K of laser frequency change with temperature variation, an exactly referenced optical carrier output could be maintained even if the slave laser 15 has its temperature varied by >>5 K.

As may be seen in FIG. 4, the reference comb signal 4A travels through a circulator 25 from port 1 to port 2, suffering a small amount of attenuation. For clarity purposes the signal emerging from the circulator 25 at port 2 will hereafter be referenced as signal 4A. Through the coupler 18, signal 4A reaches the slave laser 15 block. Before the signal 4A reaches the slave laser 15 cavity, it has a small amount of its power reflected by the slave laser 15 facet (signal 15A). This is a result of imperfect refractive index matching between the air and the semiconductor material of the laser structure. Laser facets commonly receive an anti-reflection coating treatment to diminish the amount of reflection. This coating can be customised depending on the application. For OIPLL purposes the standard power reflection of around 1% is sufficient.

As such, propagating through the same optical path (but in the reverse direction) as the reference comb signal 4A, towards the coupler 18, there exist two signals. The weak reflected portion 15A of the reference comb 4A, and the slave laser 15 locked single line emission signal 15B. By correct design, the power level of the reflected signal 15A can be maintained to be more than 40 dB below that of the locked signal 15B. This results in an optical side mode suppression ratio which complies with most system specifications. These signals have, for example, 90% of their power transmitted to the slave laser locking block 5 output, comprising the referenced optical carrier. The other 10% travels toward port 2 of the optical circulator 25, and is re-directed to port 3 to form signal 25A. This signal comprises attenuated copies of the reflected and locked signals 15A and 15B. Signal 25A is sent to the photodetector 19, and the resultant mixture of components 15A and 15B drives the PLL circuit block 24. The operation of the PLL block 24, in OIPLL, is similar to that for OPLL which has already been described above.

This approach guarantees that, as both signals 15A and 15B travel through the same optical path, the relative phase between them is only altered by variations in the slave laser conditions, and not by path length differences induced by environmental variations. However, it has to be noted that the weak reflection of the reference comb signal 4A on the slave laser 15 facet, and the posterior power division at the coupler 18, together with the attenuation added by the circulator 25, result in a weak copy of the reference comb 4A at the photodetector 19 input. Consequently a weak microwave component close to frequency f_{REF} is expected at the output of the photodetector 19 (signal 19A).

For the generation of an adequate error signal 21A to drive the control circuit 23, it is then necessary to use a higher degree of amplification in the microwave amplifier block 20 than that which is required for OPLL. However, as it is only necessary to produce a sinusoidal component at frequency f_{REF}, inexpensive narrowband amplifiers can be employed in this block. The combined utilisation of both the OIL and OPLL arrangements gives the advantage that loop delay times can reach values as high as milliseconds, whilst locking is maintained.

Another way of implementing the heterodyne OIPLL technique is to make use of the two facets present within the slave laser, as depicted in FIG. 7. This approach avoids the need for an optical circulator 25. In this case, block 17 comprises only a slave laser 15 and a coupler 18. Hence, signal 15A is a result of the attenuated portion of the reference comb signal 4A that passes through the slave laser 15 cavity. Again, both signals 15A and 15B are split at the coupler 18, having, for example, 90% of their power directed to the slave laser locking block 5 output and the other 10% directed to the photodetector 19, which drives the PLL circuit 24. All other operational aspects are as described for FIG. 4.

The heterodyne OPLL and OIPLL locking techniques described above exhibit fast acquisition and locking of the slave laser or lasers at the desired frequency or frequencies. This is best exemplified in conjunction with FIGS. 1 and 2.

Referring to FIG. 2, the time taken for the slave laser to lock to a specified frequency begins when information indicating which of the comb lines of signal 4A the slave laser should be locked to is converted into a tuning current density variation signal, i.e. a current density generated to vary the tuning current density applied to the slave laser and thus to cause it to lock to a frequency. Before the conversion can take place, the information referred to above is fed, by the channel allocation bus 12, to the current and temperature controller 16 (where the conversion takes place).

The locking circuits 5₁ to 5_{N} (see FIG. 1) compensate naturally for variations in the temperature of the residual laser chip, and for disturbances to the equilibrium of the carriers within the slave laser caused by changes to the laser tuning current density. The time taken to achieve locking of the slave laser to the desired frequency is therefore solely dictated by control loop circuit delay i.e. the time taken for a signal to travel around the control loop or, in the case of tuning within the injection locking range of an OIPLL, by the acquisition time for injection locking. Therefore, no undesired transients, such as overshoot of the desired frequency, arise during locking.

Therefore, the slave laser is locked to the required frequency in one cycle through the phase lock loop. This corresponds to less than 10 ns in most possible OPLL implementations. Similarly, the slave laser is locked to the required frequency in less than one cycle of the optical waveform when the laser is tuned within the injection range of an OIPLL. This corresponds to less then 10 fs.

It will of course be understood that the present invention has been described above by way of example only, and that modifications of detail can be made within the scope of the invention.

1-33. (Cancelled)

34. Optical Frequency Synthesizer apparatus comprising an optical frequency comb generator, a single microwave reference source where the comb line frequency spacing is the same as the microwave reference source frequency, one of its harmonics or sub-harmonics, and a plurality of slave lasers whose principal output frequencies match selected comb line frequencies; locking of each laser being achieved using a control signal formed through mixing of the photo-detected heterodyne between a fraction of the slave laser principal output frequency and residual adjacent comb lines from the optical frequency comb generator, and the microwave reference source frequency, one of its harmonics or sub-harmonics.

35. Optical Frequency Synthesizer apparatus as claimed in claim 1, wherein the optical frequency comb generator incorporates an optical phase modulator.

36. Optical Frequency Synthesizer apparatus as claimed in claim 1, wherein the slave lasers are locked using optical phase lock loops.

37. Optical Frequency Synthesizer apparatus as claimed in claim 1, wherein the slave lasers are locked using an heterodyne optical injection phase lock loop.

38. Optical Frequency Synthesizer apparatus as claimed in claim 4, wherein the optical signal to drive the loop phase-detector is obtained by using the heterodyne between the slave laser principal output frequency with the residual adjacent comb lines from the optical frequency comb generator reflected from the slave laser facet.

39. Optical Frequency Synthesizer apparatus as claimed in claim 4, where the optical signal that drives the loop phase-detector is obtained by using the heterodyne between the slave laser principal output frequency with the residual adjacent comb lines from the optical frequency comb generator transmitted through the slave laser cavity.

40. Apparatus as claimed in claim 1, wherein the laser control circuit is operable to compensate for variations in the slave laser temperature and for disturbances to the equilibrium of carriers within the slave laser.

41. A method of locking a laser output frequency, comprising the steps of:
combining a portion of a slave laser output with the output of an optical frequency comb generator in a photo-detector to generate an heterodyne signal;
combining the heterodyne signal with the output of a microwave reference source associated with the optical frequency comb generator source;
determining whether the frequency or phase of the heterodyne signal varies in relation to that of the microwave reference;
if it does then generating an error correction signal to adjust the current and/or temperature of the slave laser, in order to retain the output frequency of the slave laser at a desired frequency.

42. A method of locking a laser output frequency, utilizing the apparatus of claim 1, the apparatus configured such that the time taken to lock the laser to a frequency is comparable to the reciprocal of the loop bandwidth of the phase lock loop or one cycle of the optical waveform when the laser is tuned within the injection locking range of an optical injection phase lock loop.
